(19) United States
(12) Patent Application Publication
(10) Pub. No.: US 2005/0080663 A1
(43) Pub. Date: Apr. 14, 2005

(54) Management tool

(75) Inventor: Oliver Bauckmann, Puchheim (DE)

Correspondence Address: WILLIAM COLLARD;COLLARD & ROE, P.C., 1077 NORTHERN BOULEVARD, ROSLYN, NY, 11576, US

(73) Assignee: Kef.software AG

(21) Appl. No.: 10/681,027

(22) Filed: Oct. 8, 2003

(51) Int. Cl. G06F 17/60

(52) U.S. Cl. 705/11

(57) ABSTRACT

A method and system for computer-supported evaluation of key company figures in a management process, using an artificial neuron network. The system consists of a database connected with a data network, for storage of time series of key company figures, a control client connected with the data network, which comprises programming for interactive control of the collection and the evaluation of the key company figures and the storage of the key company figures in the database, and an evaluation server connected with the data network, which accesses the key company figures stored in the database and has programming for the statistical evaluation of the time series when using an artificial neuron network.

### BACKGROUND OF THE INVENTION

1. Field of the Invention

The invention relates to a method for computer-supported evaluation of key company figures in a management process. In addition, the invention relates to a system for implementing this method.

2. The Prior Art

The known concept of so-called “Balanced Score Cards,” developed by the two Harvard professors Kaplan and Norton, has been finding great attention since the 1990s, particularly in the United States, but also in Europe.

According to a definition of the term from the Boston Consulting Group, the system of Balanced Score Cards is a multi-criterion, balanced system of key figures, which can be used in a management process for implementing, controlling, and monitoring the corporate strategy. In this connection, the Balanced Score Card contains essential key figures that depict and secure the success of the corporate management on a strategic level, but also on an operative level.

The use of the system of Balanced Score Cards in a management process presumes that the company in question has a certain vision or mission, i.e. a goal in mind, and that it has developed a suitable strategy to implement that goal. The Balanced Score Card then links this strategy with specific key company figures. In this way, finding the right strategy is facilitated, and the consensus of all strategic goals of the company is guaranteed. Since, according to the concept of the Balanced Score Cards, the entire corporate strategy is broken down and distributed among all the individual action takers within the company, a uniform goal orientation of all the corporate actions is promoted and, in particular, a link with the corporate strategy is guaranteed when utilizing the available resources.

When using the Balanced Score Cards in a management process, the strategy of the company is therefore translated into individual sub-goals, to which key company figures are assigned, in each instance. These key company figures can be assigned to different perspectives, between which there are cause/effect relationships, to a greater or lesser degree. In this connection, the economic/financial perspective, on the one hand, and a customer perspective, an internal process perspective, and a learning and development perspective, on the other hand, are important.

It is possible to check whether or not the implementation of a strategy is making a contribution to improving the results by assessing the finances of a company. Key company figures of the financial perspective are therefore of a monetary nature. These are so-called “hard factors,” which are generally present in various EDP systems assigned to the bookkeeping of a company.

Key company figures assigned to the customer perspective, which also represent hard factors are, for example, the market share in each instance, data with regard to customer acquisition, customer loyalty, or customer profitability. However, more subjective or so-called “soft factors” are also of particular importance, such as key figures that reflect customer satisfaction, i.e. the degree of satisfaction of the customers in front of the background of specific performance criteria of the company. Such soft factors can only be determined by way of regular surveys (questionnaires, interviews, etc.).

The internal process perspective has variables such as key figures regarding quality, yield, pass-through or cycles assigned to it, for example. These figures are generally objectively determined, i.e. hard factors in the above sense.

The learning and development perspective deals primarily with the employee potentials of a company. Variables for employee potential are, for example, employee satisfaction, personnel loyalty, and employee productivity, whereby the employee satisfaction, in particular, plays the role of a significant driving factor with major effects on the other key company figures. The employee satisfaction, once again, is a soft factor in the above sense, which can be determined by means of appropriate employee surveys within the company.

The determination and evaluation of the various key company figures can be computer-supported, for practical reasons, in the implementation of the system of Balanced Score Cards within a company. For this purpose, there are so-called “management tools” that allow collecting and processing of the key company figures. In particular, such management tools are used to compare the key company figures that have been determined with the target variables that result from the strategy that has been developed, so that a determination of success is possible from the point of view of the corporate management. In addition, known management tools offer various statistical evaluation possibilities of the collected data. By means of a continuous data analysis using such management tools, even quickly changing general conditions can be detected more rapidly and the corporate strategy can be adapted accordingly, so that the formulation of new initiatives and corporate goals can take place in timely manner.

As an example, a computer-supported system for assessing the performance capabilities of a business enterprise is known from U.S. Pat. No. 6,556,974 B1. This system is based on score cards of the type described above. An essential component of the previously known management tool is a survey mechanism that allows surveying employees or customers by way of the Internet, for example. In this connection, the survey results are stored in a database and thereby allow a quantitative collection and evaluation of the most varied key company figures. The survey results, as soft factors, are used by the software together with key financial figures, as hard factors, for creating score cards. Also, the data collected by means of the software can be utilized for a determination of the degree to which goals have been reached. Furthermore, it is known, from the aforementioned U.S. patent, to use the management tool for a statistical evaluation of the key figures and the survey results, in order to estimate values expected for the future.

It is a disadvantage of the previously known management tools that they only make available a tool for collecting and administering key company figures, and other than that can only be used to carry out simple descriptive statistical calculations. The previously known tools generally do not offer any possibilities for automating the actually significant aspects of the system of Balanced Score Cards. This is because as a rule, such tools do not have any functions for automatically recognizing causal relationships between the various key company figures and describing the trends contained in the collected data by means of general rules or laws. However, uncovering such causal relationships is an essential part of the management process, for example in order to determine the influence of soft driving factors on the key financial/economic figures. This is precisely what decisions of the corporate management depend on, in order to achieve the goals that have been set.

### SUMMARY OF THE INVENTION

Proceeding from this, the invention is based on the task of making available an improved management tool. In particular, it must be guaranteed that relationships between the collected key company figures can be automatically uncovered and analyzed. In this connection, the actual purpose of the system of Balanced Score Cards, namely that of providing the corporate management with a reliable basis for decisions, in order to implement the strategy of the company as effectively as possible, stands in the foreground.

This task is accomplished, according to the invention, by means of a method for computer-supported evaluation of key company figures in a management process, whereby key company figures are first collected in the form of time series, by means of suitable mechanisms, and stored in a database. In this connection, at least some of the key company figures are determined by means of repeated employee and/or customer surveys. Afterwards, statistical evaluation of the time series stored in the database takes place, specifically using an artificial neuron network.

The essential fundamental principle of the invention accordingly consists, on the one hand, of systemically collecting the key company figures in the form of time series and, on the other hand, of using an artificial neuron network for the statistical evaluation of the collected data. Artificial neuron networks have particularly advantageous properties for use in a management tool. This is because neuron networks are able to automatically and independently recognize and model complex relationships and laws in a system of collected data, by learning them. In addition, neuron networks are free of restrictive defaults, such as those that are generally set with the usual statistical evaluation methods. Also, neuron networks have the advantage of being able to evaluate both linear and non-linear relationships between the collected data. The method according to the invention is therefore particularly suitable for computer implementation of the system of the Balanced Score Cards described above, or also of other known score-card-based systems.

According to the invention, the time series of the collected data are input into the artificial neuron network being used, whereby survey mechanisms for surveying employees and/or customers are used for the collection of the aforementioned soft factors. Key company figures relating to hard factors, such as key financial/economic figures, are present in the EDP systems assigned to the bookkeeping of a company, in any case, and can easily be included in the method according to the invention. All of the data collected in this way then form time series. This means that soft factors, as empirical data, are collected by way of employee and/or customer surveys in time synchronicity with the hard factors that are directly taken over from the appropriate data sources within the company, and therefore can be evaluated in consistent statistical manner.

Using the statistical evaluation by means of the artificial neuron network, it can then automatically be determined, according to the invention, which of the collected key figures can be influenced by which actions of the company, and which of the key figures is connected with the company success being aimed at, in what way.

It is practical if, in the method according to the invention, the said employee and/or customer surveys are conducted interactively, by way of a data network. For this purpose, existing high-performance Internet technology can be used, in that the customers of a company respond to questions of a question catalog compiled in appropriate manner, by way of the Web interface of a Web server of the company, for example. In the case of employee surveys, the Intranet of the company can be used in analogous manner. For employee surveys, in particular, there is the possibility of installing special survey clients on the PCs of the employees, which automatically have a suitable survey screen appear on the monitor of the employee PCs in question if such an employee survey is coming up. The data flow to/from the employee from/to the database is controlled automatically, in this connection. In particular, the time sequence of the key company figures is predetermined, in suitable manner, in order to collect the desired time series of the key company figures.

Before the key company figures registered in the database can be evaluated in the manner described above, it is necessary for the neuron network that is being used to be trained appropriately. The training takes place using training patterns that can be predetermined, which comprise a first set of time series of key company figures as input data and a second set of time series of key company figures as target data. By setting the training pattern, groups of key company figures can be defined, for which the user of the method according to the invention desires a corresponding statistical analysis.

In order to analyze the effects of the development of employee satisfaction on financial/economic key figures of the company, for example, it is practical if the training pattern comprises the time series of the corresponding soft factors as the input data and the said key financial figures, as hard factors, as the target data. During the training, the input neurons have the stated input data of the training pattern applied to them, whereupon the parameters of the neuron network are determined by means of suitable learning algorithms, so that the output data of the neuron network reproduce the target data of the training pattern as well as possible. It is practical, in this connection, to evaluate the success of the training using an overall error of the neuron network, which error quantitatively reflects the deviation of the output data of the neuron network from the target data of the training pattern. This overall error is calculated, for example, using the sum of the deviation squares of the output data of the neuron network from the corresponding target data.

It is particularly advantageous that according to the invention, after the training phase, the artificial neuron network being used can be used for an automatic determination of cause/effect relationships between the collected key company figures, i.e., of causalities.

For the purpose of detecting such cause/effect relationships between the input data and the target data of the training pattern, the strength of the tie between the input neurons that have the input data applied to them, in each instance, and the trained neuron network, can be evaluated. In this connection, the strength of the tie results from the corresponding network parameters that were determined during the training phase. In this connection, advantage is taken of the fact that those key company figures that are assigned to the input neurons that are only weakly tied in with the neuron network obviously have only a lesser influence on the output data of the neuron network. Vice versa, it can be concluded that marked cause/effect relationships exist between those input and output data of the neuron network to which neurons strongly tied in with the neuron network are assigned.

Alternatively, for the purpose of detecting cause/effect relationships, individual input neurons can be uncoupled from the trained neuron network, in a targeted manner, whereby then a test variable is evaluated, which reflects the influence of the uncoupling on the overall error of the neuron network. In this connection, advantage is taken of the fact that for those key company figures assigned to the input neurons that are uncoupled from the neuron network, no marked cause/effect relationships exist for the key company figures assigned to the output side of the neuron network, if the uncoupling, in each instance, affects the overall error of the neuron network which, as described above, reflects the deviation of the output data of the neuron network from the target data predetermined by the training pattern, only slightly. The strength of the influence of the key company figures assigned to the input side of the neuron network on the key company figures assigned to the output side of the neuron network can be quantitatively evaluated using the test variable. For this reason, it is practical to calculate a plurality of values of the test variable, in that individual input neurons or groups of input neurons, to which individual key company figures of the training pattern are assigned, are systematically uncoupled from the neuron network. For the purpose of evaluating causalities between the key company figures of the training pattern, the values of the test variable calculated in this way can be visualized, in suitable manner.

For the implementation of the system according to the invention, a system for the computer-supported evaluation of key company figures in a management process that comprises the following components is suitable:
a database connected with a data network, for storage of time series of key company figures,
a control client connected with the data network, which comprises programming for interactive control of the collection and the evaluation of the key company figures and the storage of the key company figures in the database, and
an evaluation server also connected with the data network, which accesses the key company figures stored in the database and has programming for the statistical evaluation of the time series when using an artificial neuron network.

It is practical if programming for implementing employee and/or customer surveys by way of the data network is furthermore integrated into the control client.

### BRIEF DESCRIPTION OF THE DRAWINGS

Other objects and features of the present invention will become apparent from the following detailed description con-sidered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a schematic representation of a neuron network being used according to the invention;

FIG. 2 shows a representation of time series of key company figures as a diagram;

FIG. 3 shows a visualization of a test variable according to the invention, for the purpose of detecting cause/effect relationships between key company figures; and

FIG. 4 shows a schematic representation of a system according to the invention, for the computer-supported evaluation of key company figures.

### DETAILED DESCRIPTION OF THE PREFERRED EMBODIMENT

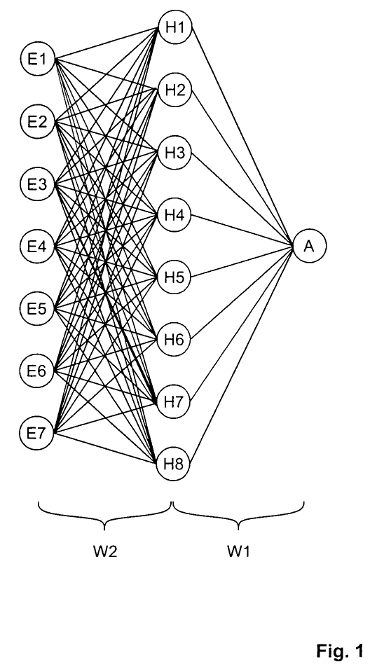

As explained above, the known statistical method of artificial neuron networks is used in the method according to the invention. FIG. 1 shows the structure of a neuron network that is suitable for the method according to the invention, of the “Multilayer Perceptron (MLP)” type. This is a two-stage forward-directed neuron network that particularly corresponds to the requirements of the method according to the invention. Fundamentally, however, other types of neuron networks can also be used.

The network shown in the figure has seven input neurons E1-E7, but fundamentally, the number of input neurons can be of any desired size. The neuron network has only a single output neuron A, since it is known that neuron networks with only one output neuron yield the most reliable results. In the example shown, eight intermediate neurons H1-H8 are furthermore provided, which are connected with the input neurons E1-E7 on the input side and with the output neuron A on the output side. The first layer of the neuron network has weighting factors W1 assigned to it as network parameters, which determine how strongly the output values of the intermediate neurons H1-H8 influence the output value of the output neuron A. Coupling of the input neurons E1-E7 to the intermediate neurons H1-H8 is determined in the second layer of the network shown, by means of the weighting factors W2.

According to the invention, the neuron network is trained with a training pattern that can be predetermined, whereby the input neurons E1-E7 of the network have time series of key company figures applied to them as input data, the causal effect of which time series on a different key company figure is supposed to be investigated. As the target data, the training pattern comprises a key financial figure collected as a time series, for example, which is supposed to be reproduced by the output value of the output neuron A. To investigate causalities using a management tool that works according to the invention, a neuron network is therefore generated for every individual effect (output value), which network comprises several input neurons with these causes (input values) assigned to them, in each instance.

The training of the neuron network takes place by means of known learning algorithms, whereby the so-called “back propagation” method has proven itself, for example. It is practical, in this connection, to evaluate the success of the training on the basis of the overall error of the neuron network, which quantitatively reflects the deviation of the output value of the output neuron A from the actual collected value of the key financial figure that is of interest. As its result, the training yields the network parameters, namely the weighting factors W1 and W2.

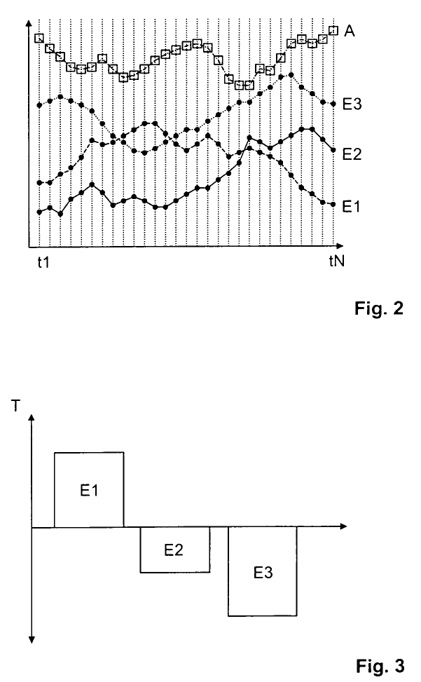

FIG. 2 shows various time series of key company figures in the form of a diagram. According to the invention, the key company figures are stored in a database, whereby the key company figures shown by black dots on the diagram are determined by means of employee and/or customer surveys repeatedly carried out at time points t1-tN. These key company figures are soft data in the above sense, which reflect the customer or employee satisfaction, for example. By means of the suitable selection and compilation of questions directed to the employees and/or customers, the soft factors are collected as empirical data, in the form of the time series shown. Open square symbols on the diagram show another time series, which is a key financial figure, in other words a hard factor. This hard factor is collected in time synchronicity with the soft factors, as is evident on the diagram, and stored in the database, so that a consistent statistical evaluation is possible.

In order to automatically determine cause/effect relationships between the key company figures shown on the diagram, according to the invention, the neuron network is trained in the manner described above, whereby the key company figures determined by means of employee and/or customer surveys are used as input data, applied to the input neurons E1, E2, and E3 of the neuron network. During the training of the neuron network, the time series of the key financial figure shown by open squares on the diagram serves as target data. The success of the training is evaluated on the basis of the overall error of the neuron network, which reflects the deviation of the output data of the output neuron A of the neuron network from the target data.

After the training of the neuron network has been completed, cause/effect relationships between the soft factors shown on the diagram and the hard factor in question can be automatically determined, according to the invention. For this purpose, the input neurons E1, E2, and E3 are uncoupled from the trained neuron network, one after the other, and in each instance, a test variable T is calculated, which reflects the influence of the uncoupling on the overall error of the neuron network. This yields a plurality of values of the test variable T, which can be visualized in the form of a diagram for the purpose of assessing possible causalities, as is shown in FIG. 3. When the input neuron E1 is uncoupled, the test variable T takes on a large positive value, which means that the overall error of the neuron network has become smaller as the result of the uncoupling. From this, it can be concluded that the input neuron E1 does not have a large influence on the output value of the output neuron A. Accordingly, there is obviously no cause/effect relationship between the soft factor assigned to the input neuron E1 and the hard factor of interest here. If, on the other hand, the input neurons E2 and E3, respectively, are uncoupled from the neuron network, the test variable T takes on different negative values, which means that the overall error of the neuron network has increased, in each instance, as a result of the uncoupling. From this, it can be concluded that the soft factor assigned to the input neuron E2 has a moderate influence, and the soft factor assigned to the neuron E3 actually has a strong influence on the hard factor in question, which is assigned to the output side of the neuron network.

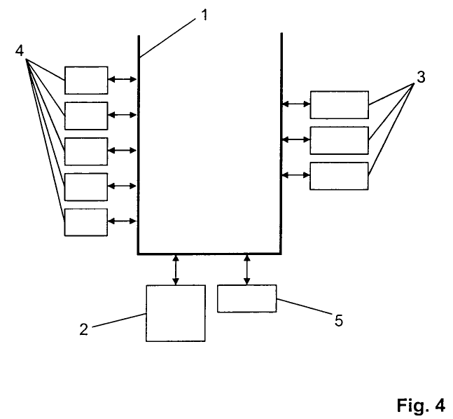

FIG. 4 schematically shows a system for the computer-supported evaluation of key company figures according to the invention. The system consists of a database 2 connected with a data network 1, to store time series of key company figures. Several control clients 3 are connected with the data network 1, which comprise programming for interactive control of the collection and the evaluation of the key company figures as well as the storage of the key company figures in the database 2. The control clients also have programming for conducting employee and/or customer surveys by way of data network 1. For this purpose, control clients 3 make contact with employee and/or customer PCs 4, so that the employees or customers being addressed can answer questions directed at them by way of data network 1. The questions can be compiled from suitable question catalogs, using the programming of control clients 3. Furthermore, an evaluation server 5 is provided, which accesses the key company figures stored in database 2, and has programming for the statistical evaluation of the time series, using an artificial neuron network, according to the invention.

Accordingly, while only a few embodiments of the present invention have been shown and described, it is obvious that many changes and modifications may be made thereunto without departing from the spirit and scope of the invention.

1. A method for computer-supported evaluation of key company figures in a management process, comprising the following steps:
collecting and storing key company figures in a database, in the form of time series, wherein at least some of the key company figures are determined by means of repeated employee or customer surveys; and
statistically evaluating the time series stored in the database, using an artificial neuron network.

2. A method according to claim 1, wherein the employee or customer surveys are conducted interactively, by way of a data network.

3. A method according to claim 1, wherein the neuron network is trained with the key company figures stored in the database, to allow a statistical evaluation.

4. A method according to claim 3, wherein the neuron network is trained with a training pattern that can be predetermined, said training pattern comprising a first set of time series of key company figures as input data and a second set of time series of key company figures as target data.

5. A method according to claim 4, wherein success of the training is evaluated using an overall error of the neuron network, which error reflects a deviation of output data of the neuron network from target data of the training pattern.

6. A method according to claim 4, wherein cause and effect relationships between the key company figures are automatically determined based on results of the training.

7. A method according to claim 6, wherein for the purpose of detecting cause and effect relationships between input data and output data, the strength of a tie between input neurons that have the input data applied to them, and the trained neuron network, is evaluated.

8. A method according to claim 6, wherein for the purpose of detecting cause and effect relationships between input data and output data, at least one input neuron to which input data are applied is uncoupled from the trained neuron network, and a test variable is evaluated, said test variable reflecting influence of the uncoupling on an overall error of the neuron network.

9. A method according to claim 8, wherein a plurality of values of the test variable is calculated by systematically uncoupling from the neuron network input neurons to which individual key company figures of the first set of the training pattern are assigned.

10. A method according to claim 9, wherein the plurality of values of the test variable is visualized, for the purpose of evaluating influence of key company figures of a first set on key company figures of a second set.

11. A system for computer-supported evaluation of key company figures in a management process, comprising the following components:
a database connected with a data network, for storage of time series of key company figures,
a control client connected with the data network, said control client comprising programming for interactive control of collection and evaluation of the key company figures and storage of the key company figures in the database (2); and
an evaluation server also connected with the data network, said server accessing the key company figures stored in the database and having programming for statistical evaluation of the time series when using an artificial neuron network.

12. A system according to claim 11, wherein the control client also has programming for conducting employee or customer surveys by way of the data network.
